(19) United States
(12) Patent Application Publication
(10) Pub. No.: US 2007/0117458 A1
(43) Pub. Date: May 24, 2007

(54) Pluggable module and cage

(75) Inventors: Paul Winker, Boulder, CO (US); Eric Larson, Boulder, CO (US); Neil Cannon, Boulder, CO (US); Andrew Kayner, Boulder, CO (US); Heike Tritschler, Boulder, CO (US)

Correspondence Address: JAGTIANI + GUTTAG, 10363-A DEMOCRACY LANE, FAIRFAX, VA, 22030, US

(73) Assignee: Picolight Incorporated, Louisville, CO (US)

(21) Appl. No.: 11/281,610

(22) Filed: Nov. 18, 2005

(51) Int. Cl. H01R 13/648

(52) U.S. Cl. 439/607

(57) ABSTRACT

The present invention provides an EMI-minimized transceiver, rectangular-shaped collar including a plurality of contact fingers for making electrical contact with a chassis in which a transceiver cage comprising the collar and the cage body is mounted.

### BACKGROUND

1. Field of the Invention

The present invention relates generally to transceiver modules and cages.

2. Related Art

Optoelectronic transceivers are utilized to interconnect circuit cards of communication links and other electronic modules or assemblies. Various international and industry standards define the type of connectors used to interface computers to external communication devices such as modems, network interfaces, and other transceivers. A well-known type of transceiver module developed by an industry consortium and known as a Gigabit Interface Converter (GBIC) provides an interface between a computer and an Ethernet, Fiber Channel, or other data communication environment. U.S. patents identified under issued U.S. Pat. Nos. 5,879,173, 5,864,468, 5,734,558, 5,717,533, and U.S. Pat. No. Re 36,820, originally assigned to Methode Electronics, Inc, and now assigned to Stratos Lightwave, both in Chicago, Ill., disclose pluggable transceiver modules. U.S. Pat. Nos. 5,879,173, 5,864,468, 5,734,558, 5,717,533, and U.S. Pat. No. Re 36,820 are hereby incorporated by reference.

It is desirable to miniaturize transceivers in order to increase the port density associated with the network connection (switch boxes, cabling patch panels, wiring closets, computer I/O, etc.). Various standards are known that define form factors for miniaturized electronic devices, such as the Small Form-Factor Pluggable (SFP) standard that specifies an enclosure 9.8 millimeters in height by 13.5 millimeters in width and having a minimum of 20 electrical input/output connections. The specific standards for SFP transceivers are set forth in the “Small Form-Factor Pluggable (SFP) Transceiver Multisource Agreement (MSA),” dated Sep. 14, 2000, which are hereby incorporated by reference.

However, increasing data rates in optoelectronic transceivers result in the generation of higher-frequency electromagnetic interference (EMI) radiation. Since the higher-frequency EMI has shorter wavelengths, shielding against such EMI becomes increasingly difficult. In particular, the maximum allowable hole or aperture size in a system becomes smaller. The problem is most severe for systems utilizing “pluggable” modules, which may be repeatedly plugged into and unplugged from a system chassis.

### SUMMARY

According to a first broad aspect of the present invention, there is provided a device comprising an EMI-minimized transceiver.

According to a second broad aspect of the invention, there is provided a device comprising: a rectangular-shaped collar comprised of an electrically conductive material, the collar including: four collar sides for mounting on four exterior sides of a cage body; and a plurality of contact fingers on the four collar sides for making electrical contact with a chassis in which a transceiver cage comprising the collar and the cage body is mounted.

According to a third broad aspect of the invention, there is provided a device comprising: a collar piece including: one or more contact fingers for mounting on an exterior side of cage body and for making electrical contact with a chassis in which a transceiver cage comprising the collar and the cage body is mounted, wherein the exterior side includes an opening for receiving a locking latch of a transceiver inserted in a transceiver comprising the collar piece and the cage body.

### BRIEF DESCRIPTION OF THE DRAWINGS

The invention will be described in conjunction with the accompanying drawings, in which:

FIG. 1A is a top perspective view of an EMI-minimized transceiver module in accordance with one embodiment of the present invention;

FIG. 1B is a bottom perspective view of the transceiver module of FIG. 1A;

FIG. 1C is a top perspective exploded view of the transceiver module of FIG. 1A;

FIG. 1D is a bottom perspective exploded view of the transceiver module of FIG. 1A;

FIG. 2A is a top perspective view of the transceiver frame of the transceiver module of FIG. 1A;

FIG. 2B is a bottom perspective view of the transceiver frame of FIG. 2A;

FIG. 3A is a top perspective view of the circuit board assembly of the transceiver module of FIG. 1A, with details of the circuit board, such as chips mounted on the circuit board, omitted for convenience;

FIG. 3B is a bottom perspective view of the circuit board assembly of FIG. 3A;

FIG. 4A is a top perspective view of the transceiver housing of the transceiver module of FIG. 1A;

FIG. 4B is a bottom perspective view of the transceiver housing of FIG. 4A;

FIG. 5A is a top perspective view of the EMI shield of the transceiver module of FIG. 1A;

FIG. 5B is a bottom perspective view of the EMI shield of FIG. 5A;

FIG. 6A is a top perspective view of the transceiver collar of the transceiver module of FIG. 1A;

FIG. 6B is a bottom perspective view of the transceiver collar of FIG. 6A;

FIG. 6C is a top perspective view of the transceiver collar piece of the transceiver module of FIG. 1A;

FIG. 6D is a bottom perspective view of the transceiver collar piece of FIG. 6C;

FIG. 7A is a top perspective view of the transceiver rocker of the transceiver module of FIG. 1A;

FIG. 7B is a bottom perspective view of the transceiver rocker of FIG. 7A;

FIG. 8A is a top perspective view of the handle of the transceiver module of FIG. 1A;

FIG. 8B is a bottom perspective view of the handle of FIG. 7A;

FIG. 9A is a top perspective view of the transceiver module of FIG. 1A with the transceiver housing removed to show internal structures;

FIG. 9B is a bottom perspective view of the transceiver module of FIG. 9A with the transceiver housing removed to show internal structures;

FIG. 10A is a top perspective view of the transceiver module of FIG. 9A with the transceiver housing and a lens removed to show internal structures;

FIG. 10B is a top perspective view of the transceiver module of FIG. 10A with the transceiver housing and circuit board assembly removed to show internal structures.

FIG. 11B is a bottom perspective view of a transceiver module in accordance of one embodiment of the present invention;

FIG. 11B is a cross-sectional schematic side view of a transceiver collar piece mounted on the transceiver housing of the transceiver module FIG. 10A;

FIG. 12A is a top perspective view of a cage collar in accordance with one embodiment of the present invention;

FIG. 12B is a bottom perspective view of the a cage collar of FIG. 12A;

FIG. 13A is a top perspective view of a cage body in accordance with one embodiment of the present invention;

FIG. 13B is a bottom perspective view of the cage body of FIG. 13A;

FIG. 14A is a top perspective view of a transceiver cage in accordance with one embodiment of the present invention;

FIG. 14B is a bottom perspective view of the transceiver cage of FIG. 14A;

FIG. 15A is a top perspective view of the transceiver module of FIG. 1A inserted in the transceiver cage of FIG. 14A;

FIG. 15B is a bottom perspective view of the transceiver module and transceiver cage of FIG. 15A;

FIG. 16A is a top perspective view of a cage collar in accordance with one embodiment of the present invention;

FIG. 16B is a bottom perspective view of the a cage collar of FIG. 16A;

FIG. 17A is a top perspective view of a cage body in accordance with one embodiment of the present invention;

FIG. 17B is a bottom perspective view of the a cage body of FIG. 17A;

FIG. 18A is a top perspective view of a transceiver cage in accordance with one embodiment of the present invention;

FIG. 18B is a bottom perspective view of the transceiver cage of FIG. 18A;

FIG. 19A is a top perspective view of the transceiver module of FIG. 1A inserted in the transceiver cage of FIG. 18A;

FIG. 19B is a bottom perspective view of the transceiver module and transceiver cage of FIG. 19A;

FIG. 20 is a cross-sectional schematic side view of a side flap of a cage body being “crimped” at aligned openings to the side the cage body to hold the cage together in accordance with one embodiment of the present invention;

FIG. 21 is a schematic illustration of a cage assembly including eight (8) separate 1×1 cages mounted on both sides of a printed circuit board in a “belly-to-belly” configuration in accordance with one embodiment of the present invention;

FIG. 22 is a schematic illustration of a cage assembly including two (2) separate 1×4 multi-cages mounted on both sides of a printed circuit board in a “belly-to-belly” configuration in accordance with one embodiment of the present invention;

FIG. 23 is a schematic illustration of a cage assembly including four (4) separate 2×1 multi-cages mounted on one side of a printed circuit board in accordance with one embodiment of the present invention; and

FIG. 24 is a schematic illustration of a cage assembly including a single 2×4 multi-cage mounted on one side of a printed circuit board in accordance with one embodiment of the present invention.

### DETAILED DESCRIPTION

It is advantageous to define several terms before describing the invention. It should be appreciated that the following definitions are used throughout this application.

Definitions

Where the definition of terms departs from the commonly used meaning of the term, applicant intends to utilize the definitions provided below, unless specifically indicated.

For the purposes of the present invention, the term “EMI” refers to the emission of electromagnetic radiation. For example, EMI may originate: from high frequency signals within a transceiver module, from high frequency signals propagating within a transceiver module or from a system comprising one or more modules, etc.

For the purposes of the present invention, the term “EMI-minimized transceiver” or “EMI-minimized transceiver module” refers to a transceiver that has minimized the amount of electro-magnetic interference caused by emission, immunity, or ESD (electro-static discharge) by only having the following openings: (1) openings for receiving one or more optical connectors, (2) an opening for receiving an SFP connector, and (3) a latch opening for receiving a latch.

For the purposes of the present invention, the term “bottom” refers to the side of a transceiver module or assembly that includes exposed circuit board assembly contacts.

For the purposes of the present invention, the term “central axis” refers to an imaginary line drawn through the center of a transceiver module or assembly drawn between the proximal and distal ends of the transceiver module or assembly.

For the purposes of the present invention, the term “distal” refers to the end of a transceiver housing or transceiver cage of the present invention opposite to the proximal end.

For the purposes of the present invention, the term “downwards” refers to the direction towards the bottom side of a transceiver module or assembly.

For the purposes of the present invention, the term “inwards” refers to any direction towards the interior or a central axis of a transceiver module.

For the purposes of the present invention, the term “length” refers to the length of an object along the central axis of the object.

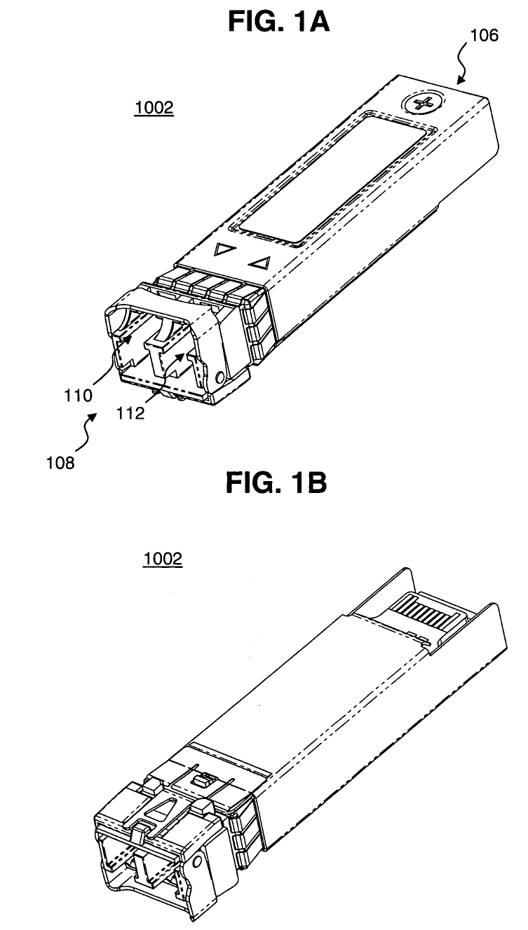

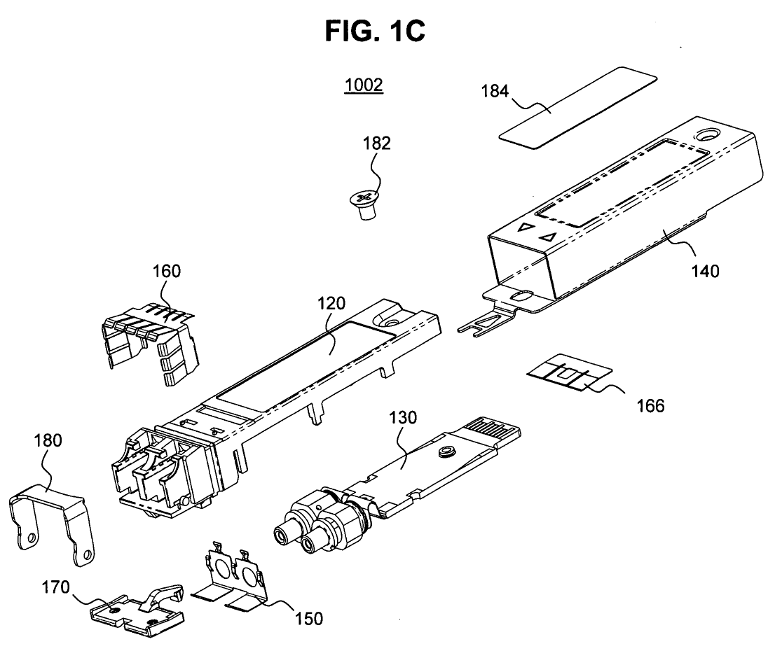

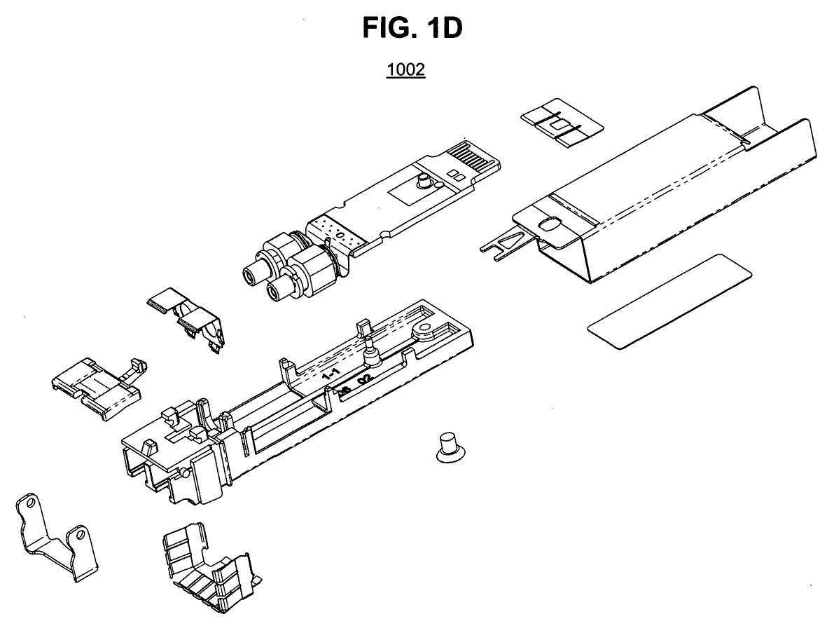

For the purposes of the present invention, the term “opening-free” refers to a portion of a transceiver and/or a cage that is free of openings. For example, FIGS. 1A-1B show a transceiver that has two opening-free sides. When assembled as a transceiver, the top of the transceiver of FIGS. 1A-1B is also opening free, because the screw opening is plugged by a screw.

For the purposes of the present invention, the term “optical receptacle” refers to a device comprising at least two ports. In the case of two ports, one port may be for a receiving a signal and another port for transmitting a signal, both ports may be for transmitting signals, or both ports may be for receiving signals. An optical receptacle may have a separate body, may be part of a transceiver frame, or may consist of two ports of a multi-optical receptacle assembly. For convenience, unless specified otherwise specified, each pair of ports in a multi-optical receptacle assembly of the present invention may be viewed as comprising an optical receptacle.

For the purposes of the present invention, the term “proximal” refers to the end of a transceiver, transceiver housing, transceiver cage, etc. in which an optical receptacle is formed, mounted, located, etc.

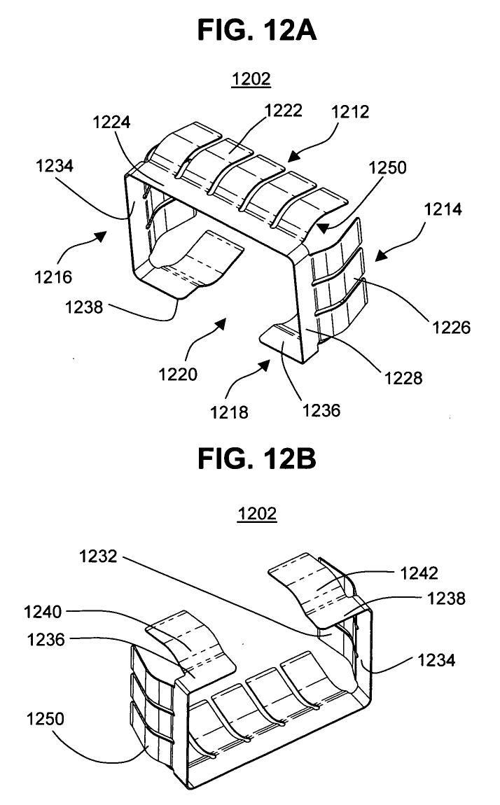

For the purposes of the present invention, the term “receiving” refers to an object, such as a tab, extending into or through an opening or into a recess. For the rocker latch in FIG. 1B is received by the latch opening in the transceiver housing. An object received by an opening may engaged the edge or rim of the opening. For example, in FIG. 12B, the rocker latch is received by and engages the opening in the transceiver cage.

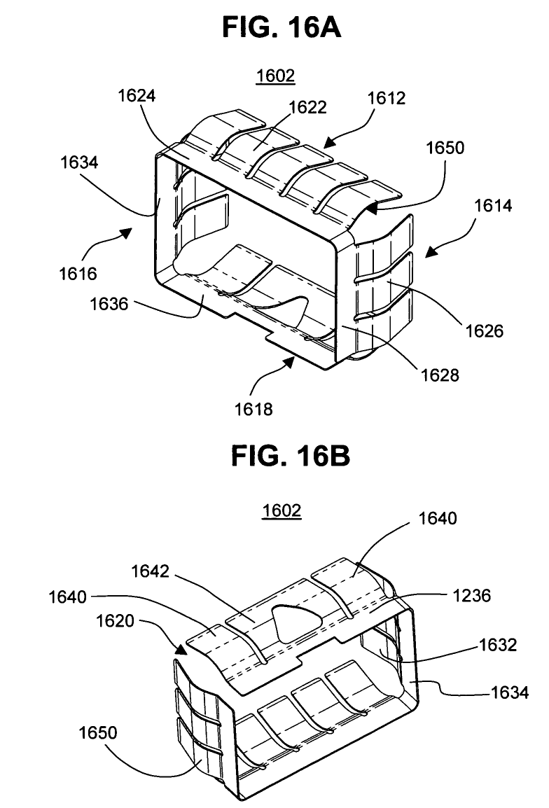

For the purposes of the present invention, the term “rectangular-shaped” refers to any object, such as a collar, that is generally rectangular in shape. A rectangular-shaped object may have an open corner, such as the rectangular-shaped collar illustrated in FIGS. 16A and 16B. A rectangular-shaped object may also have a partially open side, such as the rectangular-shaped collar and collar piece assembly illustrated in FIGS. 12A and 12B.

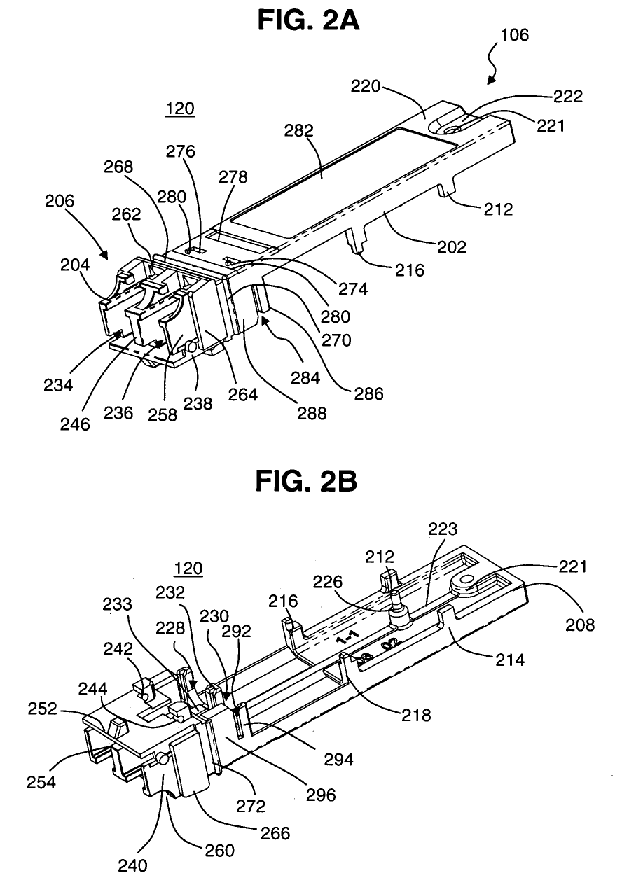

For the purposes of the present invention, the term “rectangularly arranged” refers to objects that are arranged in the generally shape of a rectangle. For example, the collar and collar piece of FIG. 2 are rectangularly arranged. Although only a few types of rectangular arrangements are shown in the embodiments of the present invention described below and shown in the drawings, there are many ways that collar pieces may be rectangularly arranged on a transceiver and/or cage. For example, four collar pieces may be rectangularly arranged on four respective sides of a transceiver and/or cage.

For the purposes of the present invention, the term “tongueless” refers to a transceiver cage that does not include a bottom spring that interacts with the latch mechanism of the a transceiver module inserted in the transceiver cage.

For the purposes of the present invention, the term “top” refers to the side of a transceiver module or assembly opposite to the bottom side of the transceiver module or assembly.

For the purposes of the present invention, the term “transceiver” refers to an electrical or optical transmitter, an electrical or optical receiver, or an electrical or optical transceiver. Unless otherwise specified, a “transceiver” refers to an optical transceiver comprising two ports, one port comprising a transmit port and one port comprising a receive port.

For the purposes of the present invention, the term “traverses” refers to a collar or collar piece that extends entirely or substantially across the width of an exterior side of a transceiver cage.

For the purposes of the present invention, the term “unibody construction” refers to a transceiver module or transceiver cage, or any part of a transceiver module that may be made from a single piece of material.

For the purposes of the present invention, the term “upwards” refers to the direction towards the top side of a transceiver module or assembly.

For the purposes of the present invention, the term “width” refers to the width of an object from left to right.

For the purposes of the present invention, the terms “left” and “right” refer to the left and right sides of a transceiver module or transceiver cage as viewed from the proximal end of the transceiver module or transceiver cage.

### DESCRIPTION

Storage area networking is presently in transition from communicating at a data rate of 2.125 Gb/s to 4.25 Gb/s. EMI levels are unacceptably high in most present 4.25 Gb/s SFP modules and the industry is looking further to the next projected speeds for Storage Area Networks (SAN). In SAN, the speeds increase by factors of 2, and designs are being laid out for 8.5 Gb/s and 17 Gb/s systems and modules. An industry consortium named SFF (after small form factor) has an ad hoc Mechanical Committee investigating the SFP module and cage structures and EMI shielding for SFP's working mainly at 4.25, 8.5 and 17 Gb/s, but also at 2.125 and 1.0625 Gb/s.

A proposed cage presented by Tyco proposes to shield most of the EMI by using “EMI fingers” both on the outside and inside of the cage, which negates any need for EMI fingers on the modules. Present-day cages and modules have EMI fingers on the outside of the cage and on the outside of the modules. Adding EMI fingers to the inside of the cage presents some problems. EMI fingers on the outside of a module can get locked with the internal EMI fingers of the cage, preventing any unplugging of the module. Also the internal EMI fingers can scratch and damage module labels, which often have barcodes for rapid identification. The Tyco cage is formed as follows. A single piece of metal is bent and cut to form the basic cage body (as described in U.S. Pat. No. 6,780,053 to Yunker et al.). Three additional pieces of metal are bent and cut, each one forming a set of internal and external fingers for one side of the cage's front end (left, right or top side). Each set of fingers is pressed onto the cage body. The bottom of the cage's front end is left without EMI fingers in order to accommodate the latching mechanism, i.e. the module latch and the latch opening. This leaves a large opening for EMI to escape the system. Tyco recommends a module having no EMI fingers for this cage, however, it is generally compatible with existing modules other than the possible locking of EMI fingers as stated above.

In one embodiment of the present invention, there is provided an transceiver cage for reducing EMI emissions from a transceiver module inserted in the cage. One part of the cage is a body, possibly comprising a single piece of sheet metal bent into the desired shape and spot-welded to itself, as described in U.S. Pat. No. 6,780,053 to Yunker et al. A second piece of bent metal forms the external EMI fingers. Having the EMI fingers as a separate piece of metal from the cage body allows the fingers to be wider and with narrower gaps between them than if they were integrated into the cage body. The narrower gaps are essential for shielding higher-frequency EMI. Unlike Tyco's EMI fingers, the EMI fingers of the present invention: (1) may comprise a single piece of metal rather than 3 pieces; 2) may cover all 4 sides of the cage, including the bottom, rather than only 3 sides, thereby providing superior EMI shielding; (3) may be spot-welded to the cage body rather than press fit; and (4) may be mounted only on the exterior of the cage body, thereby preventing any “locking” with a transceiver module having EMI fingers. Such a design may be superior in EMI shielding capability, in utility, and in manufacturability, due to having fewer parts. Furthermore, having the EMI fingers spot-welded to the cage body creates a mechanically more robust cage. The EMI fingers may alternatively be riveted, soldered, or press fit to the cage body, in some cases with appropriate modifications. This cage of the present invention may be designed to be compatible with all known versions of commercial SFP modules.

In another embodiment of the present invention, there is provided a cage that has the following features: (1) The bottom of the front of the cage may be solid, rather than depressable, thereby forming a better EMI shield and being more robust, (2) EMI fingers traverse the entire bottom of the front of the cage, thereby improving the EMI shielding even further, (3) a hole in the bottom middle EMI finger, approximately aligned with the latch opening, facilitates a latching with a transceiver module inserted into the cage. Such a transceiver cage may be made compatible to latching with most, if not all, known commercial SFP modules.

In another embodiment of the present invention, there is provided an SFP module that minimized EMI leakage. Many of the features, including movement of the latch by the bail, are described in U.S. patent application Ser. No. 10/781,916 to Kayner et al., the entire contents and disclosure of which are incorporated herein by reference. Improvements include the EMI fingers, which are similar in form to the EMI fingers of the transceiver cages described above, but the EMI fingers are welded to the interior of the module sheath and reside across the left, right, and top sides only. Another improvement is that the assembly screw which securely holds the module sheath to the die-cast module body. The assembly screw is may be made of an electrically conductive material and may be in electrical contact with the module body and the module sheath. With this construction, there is no need for features resulting in holes in the module sheath (e.g. the side springs 1374 and 1376 of FIGS. 1A and 1B of U.S. patent application Ser. No. 10/781,916 to Kayner et al.). Thus, the use of an assembly screw improves both the mechanical robustness and EMI shielding. The feature of having no holes in the module sheath also has advantages over prior transceiver module designs. EMI fingers may also be provided on the bottom side of the module sheath for better EMI shielding. A hole through the middle finger allows the latch to operate.

The transceiver cage embodiments and transceiver module embodiments described above are described in more detail below.

FIGS. 1A, 1B, 1C and 1D illustrate an EMI-minimized transceiver module 102 in accordance with one embodiment of the present invention. Transceiver module 102 has a distal end 106, a proximal end 108, a receive side 110, and a transmit side 112. Transceiver module 102 is comprised of a transceiver frame 120, a circuit board assembly 130, a transceiver housing 140, an EMI shield 150, a transceiver collar 160, a transceiver collar piece 166, a rocker 170, a handle 180, a 182, and a label 184.

A label of the present invention may include an adhesive on a bottom side thereof for adhering the label to transceiver frame. A label of the present invention may be made of any type of material that may be adhered to metal such as a piece of tape, a sticker, etc. A label may include various types of indicia on the top side relating to the manufacturer of the transceiver module, the serial number of the transceiver module, a bar code, etc.

As shown in FIGS. 2A and 2B, transceiver frame 120 includes a base portion 202 connected to optical receptacle 204 at a proximal end 206 of transceiver frame 120. Transceiver frame 120 also has a distal end wall 208. Extending downwards from base portion 202 are support tabs 212 and 214 and anti-rotation posts 216 and 218. A top side 220 includes a screw hole 221 in a screw depression 222. A ridge 223 extends along a central axis on a bottom side 224 of base portion 202. A mounting pin 226 extends downwardly from ridge 223. Transceiver frame 120 also includes a right lens mount recess 228 and a left lens mount recess 230 that share and are separated from each other by a center post 232. Opposite center post 232 is a center wall 233. Optical receptacle 204 includes two openings 234 and 236, two handle pivot pin 238 and 240 and two curved rocker pivot rests 242 and 244. A wall 246 separates openings 234 and 236. A flat receptacle base portion 252 of optical receptacle 204 includes an abutment tab 254. Optical receptacle 204 includes a top portion 256, a right side 258 and a left side 260. Top portion 256 includes a top protection rib 262. Optical receptacle 204 also includes a right side handle rest 264, a left handle rest 266, a top ridge 268, a right side ridge 270, and a left side ridge 272. Top side 220 includes a right side opening 274, a left side opening 276, a contact recess 278, two bumps 280, and a top recess 282. A right slot 284 is defined by a right post 286 and a right side wall 288 and a left slot 292 is defined by a left post 294 and a left side wall 296. Right post 286 and left post 294 also form part right lens mount recess 228 and a left lens mount recess 230, respectively.

The top recess shown in FIGS. 2A and 2B may be omitted in some embodiments of the present invention. The transceiver frame of the present invention may be made of a cast metal, such as cast zinc and, furthermore, may be metallized, for example, with nickel.

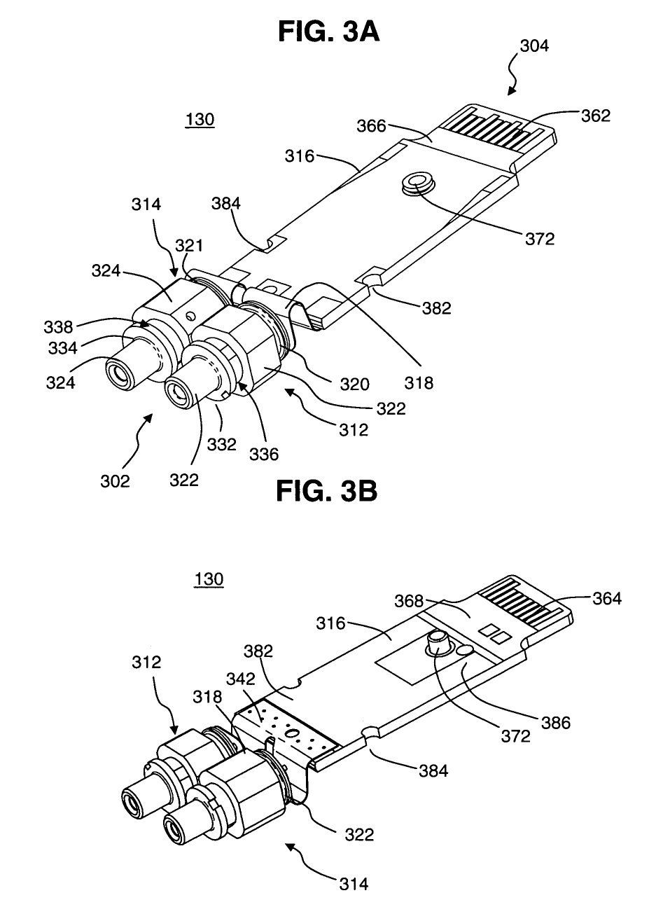

As shown in FIGS. 3A and 3B, circuit board assembly 130 has a proximal end 302 and a distal end 304 and comprises optical subassemblies 312 and 314 that are joined to a printed circuit board 316 by flex circuit 318. Optical subassemblies 312 and 314 comprise lens mounts 320 and 321, respectively, and barrel lenses 322 and 324, respectively. Barrel lenses 322 and 324 include proximal ends 326 and 328 and ring sections 332 and 334, respectively. Between ring sections 332 and 334 and lens mounts 320 and 321, respectively, are gaps 336 and 338, respectively. Flex circuit 318 includes a flex-board contact 342 that mounts and electrically contacts flex circuit 318 to circuit board 316. Top contacts 362 and bottom contacts 364 are located on a top surface 366 and a bottom surface 368, respectively, of printed circuit board 316 at a distal end 304. Along a central axis of top surface 366 is a pin receptacle 372 having a latched bottom end 374 extending perpendicularly from bottom surface 368. Printed circuit board 316 includes two side recesses 382 and 384. A setup contact 386 on printed circuit board 316 provides additional electrical access to transceiver module 102, for example, in order to allow automated setup of transceiver module 102.

The circuit board assembly of the present invention is similar in form to assemblies such as the assemblies described in U.S. Pat. No. 6,780,053 to Yunker et al., the entire contents and disclosure of which is incorporated herein by reference.

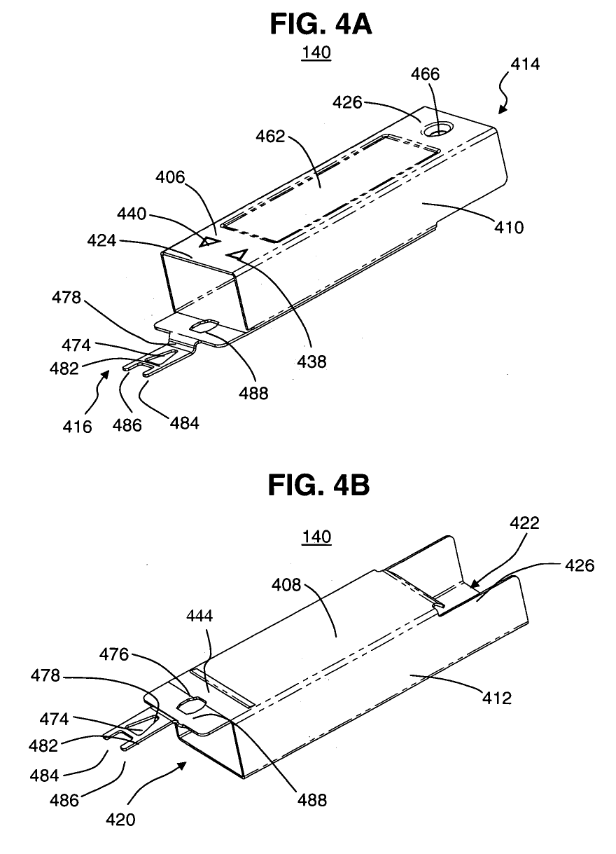

As shown in FIGS. 4A and 4B, transceiver housing 140 has a top side 406, a bottom side 408 and a right side 410, and a left side 412. Transceiver housing 140 also includes distal end 414 and proximal end 416. Transceiver housing 140 is hollow and includes a proximal opening 420, a distal opening 422, a proximal top end 424, and distal top end 426. A right arrow 438 and a left arrow 440 is inscribed in proximal top end 424. Right arrow 438 points toward distal end 106 of transceiver module 102 to indicate data coming into receive side 110 transceiver module 102, and left arrow 440 points toward proximal end 108 of transceiver module 102 to indicate data going out of transmit side 112 of transceiver module 102. Top side 406 includes a top recess 462 that is slightly larger than label 170. Top side 406 also includes a screw hole 466. When transceiver module 102 is assembled, screw 182 is screwed into screw hole 466 and screw hole 221 to hold together transceiver housing 140 and transceiver frame as one unit, as shown in FIG. 1A. A rocker return spring 474 extends proximally from a proximal end 476 of bottom side 410 and includes a bend 478, a triangular latch opening 482, and two prongs 484 and 486. Proximal end 476 includes a latch opening 488. Top side 406, right side 410, and a left side 412 of transceiver housing 140 and distal end wall 208 of transceiver frame 120 all extend farther in the distal direction than distal end 304 of circuit board assembly 130, i.e. distal end 304 of circuit board assembly 130 does not protrude from the assembly of transceiver frame 120 and transceiver housing 140.

The transceiver housing shown in FIGS. 4A and 4B has a unibody construction. However, transceiver housings of the present invention may be formed from two or more parts. The transceiver housing of the present invention may be formed by cutting, bending and punching one or more pieces of a single sheet of a metal such as steel.

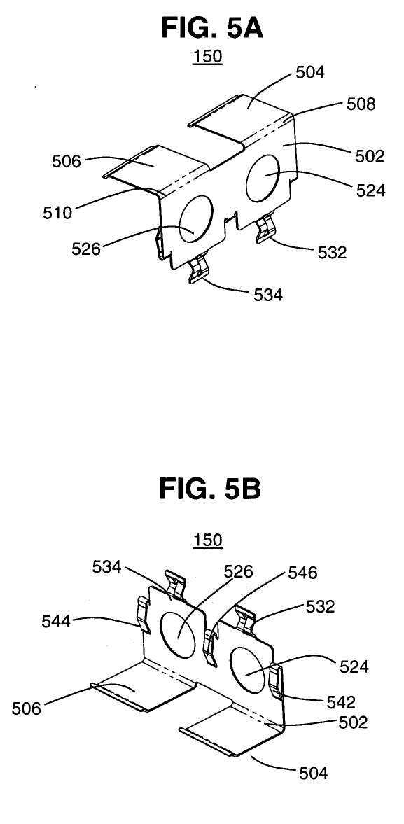

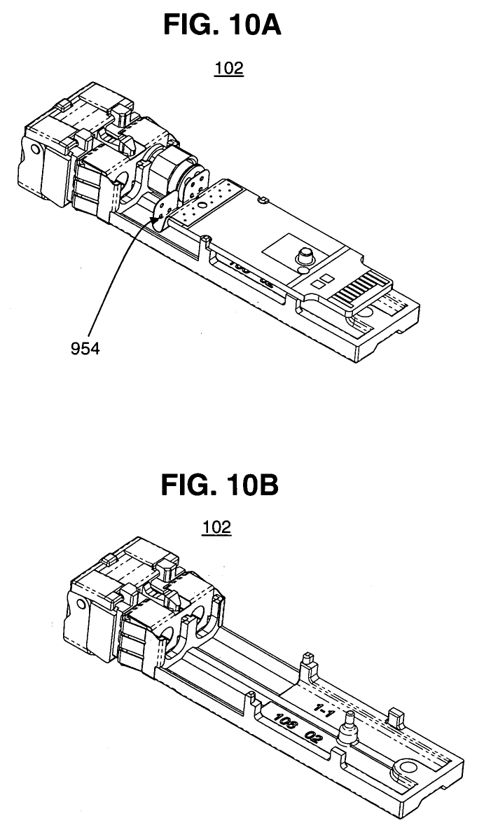

As shown in FIGS. 5A and 5B, EMI shield 150 includes a vertical plate 502 and two contact fingers 504 and 506 having respective bends 510. Vertical plate 502 includes openings 524 and 526 through which barrel lenses 322 and 324, respectively, extend when transceiver module 102 is assembled as shown in FIGS. 1A and 1B. When transceiver module 102 is assembled, vertical plate 502 slides into right slot 284, left slot 286, and between center post 232 and center wall 233 of transceiver frame 120, as shown in FIG. 10, so that plate tab springs 532 and 534 are received and springably engage, i.e. are compressed by, right side and left side openings 274 and 276, respectively. Plate face springs 542 and 544 springably engage right and left slots 284 and 286, respectively, and plate face spring 546 springably engage center post 232 and center wall 233. EMI shield 150 helps provide EMI shielding in the region of barrel lenses 322 and 324.

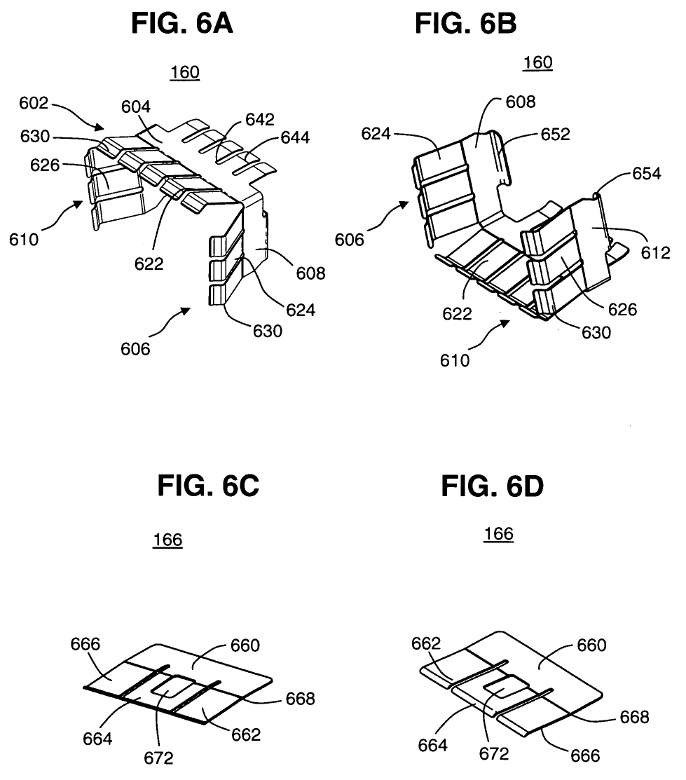

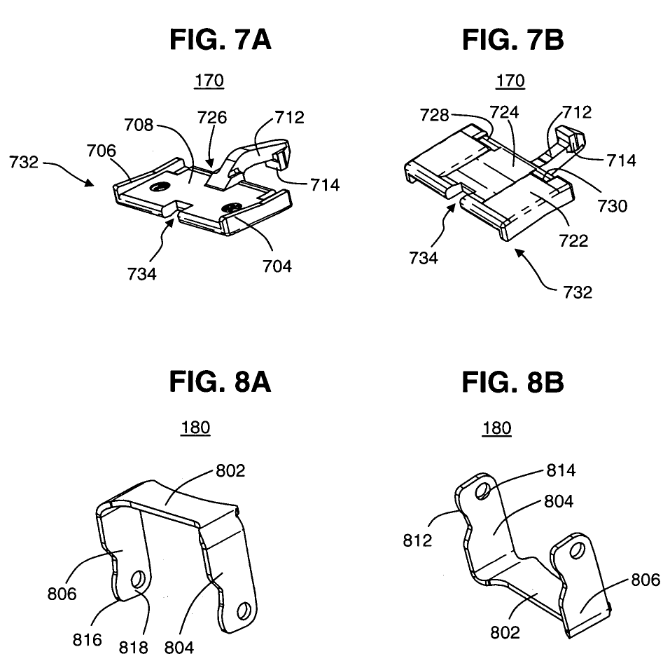

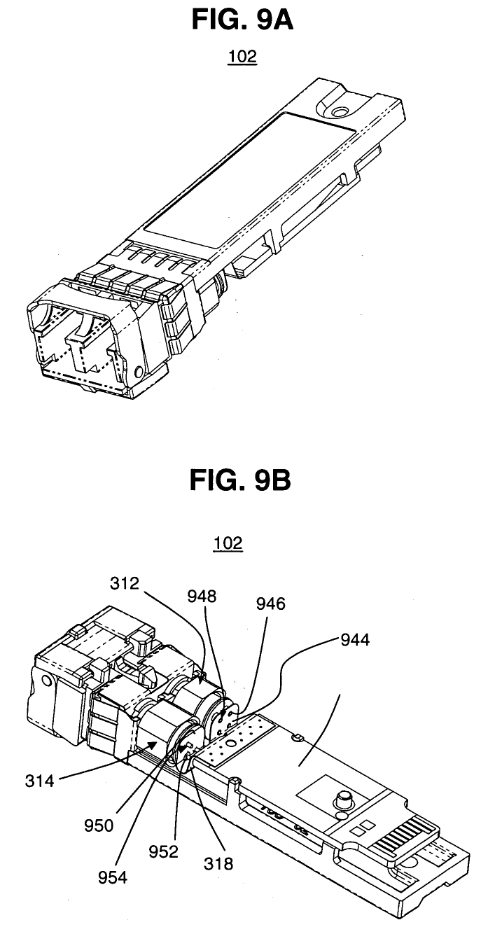

As shown in FIGS. 6A and 6B, transceiver collar 160 has a top side 602 including a top base portion 604, a right side 606 including a right base portion 608 and a left side 610 including a left base portion 612. Five top contact fingers 622 extend at an angle from top base portion 604, three right side contact fingers 624 extend at an angle from right base portion 608, and three left side fingers 626 extend at angle from left base portion 612. Fingers 622, 624 and 626 include respective bends 630. Top base portion includes five distal contact fingers 642 that include respective bend 644. Right base portion 608 and left base portion 610 include bent retaining portions 652 and 654, respectively, as shown FIGS. 9B, 10A and 10B. Transceiver collar 160 fits over EMI shield 150 so that distal contact fingers 642 are received by contact recess 278, as shown in FIG. 9A. Bent retaining portions 652 and 654 wrap around and engage right and left posts 286 and 294 as shown in FIGS. 9B, 10A and 10B. Transceiver collar 150 is held in place by transceiver housing 140 pressing against transceiver collar 160 and distal contact fingers 642 pressing against transceiver housing 140 when transceiver housing 140 is: (1) slid into place over transceiver frame 120 and transceiver collar 160 and (2) held against transceiver frame 120 by tightening screw 182. Bumps 280 of transceiver frame 120 prevent transceiver collar 160 from moving distally once transceiver collar 160 is in place on transceiver frame 120.

As shown in FIGS. 9B and 10A, optical subassembly 312 is mounted and electrically contacted to right portion 944 of flex circuit 318 by contact pins 946 of optical subassembly 312 that extend through openings 948 of flex circuit 318. Left optical subassembly 314 is mounted and electrically contacted to a left portion 950 of flex circuit 318 by contact pins 952 of optical subassembly 314 that extend through openings 954 in flex circuit 1218.

The transceiver collar shown in FIGS. 6A and 6B has a unibody construction and may be formed by cutting, bending and punching a single sheet of a metal such as steel. The transceiver collar may also be thinner than the transceiver housing.

Transceiver collar may also be further held in place by fixing the transceiver collar to the transceiver frame by spot welding, the “coining” procedure described below, etc.

As shown in FIGS. 6C and 6D, transceiver collar piece 166 includes a base portion 660 from which extends three contact fingers 662, 664 and 666 having respective base bends 668 and proximal bends 670. Contact finger 664 includes a latch opening 672 through which rocker latch 714 extends. Contact fingers 662, 664 and 666 extend at an angle from a receptacle base portion 252.

The transceiver collar piece shown in FIGS. 6C and 6D has a unibody construction and may be formed by cutting, bending and punching a single sheet of a metal such as steel. The transceiver collar piece may also be thinner than the transceiver housing and may have the same or different thickness than the transceiver collar.

Together transceiver collar 160 and transceiver collar piece 166 have a rectangular arrangement when transceiver module is assembled, as shown in FIGS. 1A and 1B, and may be viewed as forming a two piece “transceiver collar” that surround the transceiver frame on four sides.

In the embodiment of the transceiver module shown in FIGS. 1A and 1B, the transceiver collar piece is held on transceiver module by spot welding. However, various means may be used to hold the transceiver collar piece on the transceiver module, such as the “coining” procedure described below.

In some embodiments of the present invention, the transceiver collar pieces my be omitted and just a three-side transceiver collar, such as transceiver collar 160 may be used alone. In other embodiments, the transceiver collar may include a fourth side similar in shape to the transceiver collar piece and the transceiver collar may include a corner opening, similar to the corner opening of the cage collar describe below.

The contact fingers of the transceiver collar and transceiver collar piece of the present invention may have various finger widths. The contact fingers of the transceiver collar and/or collar piece of the present invention may have various finger widths. In one embodiment of the present invention, the contact fingers have a finger width of about 2 mm. The gaps between adjacent contact fingers may be of various sizes. In one embodiment the gaps between adjacent contact fingers are about 0.5 mm. In some embodiments of the present invention, there may just be a single solid contact finger on each side of the transceiver collar and/or the transceiver collar piece may include just a single finger across the width of the transceiver collar piece.

Rocker 170 includes a body portion 702 including two raised edges 704 and 706. Extending from a top surface 708 of body portion 702 is a curved arm 712 including a rocker latch 714. A bottom surface 722 of body portion 702 includes a shallow recess 724. At a distal end 726 of rocker 170 are right recess pivot 728 and left recess pivot 730. Right recess pivot 728 and left recess pivot 730 are joined to shallow recess 724. At a proximal end 732 of rocker 170 is a notch 734.

In one embodiment, the rocker of the present invention may be made of a cast metal, such as cast zinc and, furthermore, may be metallized, for example, with nickel.

Handle 180 has a cross piece 802 and two handle arms 804 and 806. Arm 804 includes a cam 812 and a pivot hole 814 and arm 806 includes a cam 816 and a pivot hole 818. Cross piece 802 includes a slot 822. As shown in FIGS. 1A and 1B, handle 180 is pivotably mounted on optical receptacle 204 by pivot holes 814 and 818 and pivot pin 238 and 240.

The handle of the present invention preferably has a unibody construction and is formed by cutting, bending and punching a single sheet of a metal such as stainless steel.

When circuit board assembly 130 is mounted on transceiver frame 120, mounting pin 226 of transceiver frame 120 extends into a pin receptacle 372 in printed circuit board 316 of circuit board assembly 130. Anti-rotation posts 216 and 218 extend through side recesses 382 and 384, respectively, of printed circuit board 316. Support tabs 212 and 214 of transceiver frame 120 support printed circuit board 316. Gaps 336 and 338 of respective optical subassemblies 312 and 314 of circuit board assembly 130 rest in respective recesses 228 and 230 of transceiver frame 120. Barrel lenses 322 and 324 extend into distal ends (not shown) of respective openings 234 and 236 of optical receptacle 204.

Circuit board assembly 130 and transceiver frame 120 are further held together by transceiver housing 140, shown in detail in FIGS. 4A and 4B, that fits around circuit board assembly 130 and transceiver frame 120 to insure that mounting pin 226 remains lodged in pin receptacle 372 to hold transceiver frame 120 in place with respect to transceiver housing 140. As shown in FIGS. 6A and 6B, rocker 170 is held on base portion 252, of optical receptacle 204 by rocker return spring 474 by the interaction of right recess pivot 728 and left recess pivot 730 and rocker pivot rests 242 and 244, respectively. Rocker return spring 474 lies in shallow recess 724. Notch 734 abuts abutment tab 254.

In a latched position shown in FIGS. 1A and 1B, handle 180 is in an upright position and right and left handle arms 804 and 806 rest against right and left side handle rests 264 and 266, respectively. Cams 812 and 816 abut raised edges 704 and 706 of rocker 170 prevent handle 180 from pivoting without force being applied. Rocker 170 is held against receptacle base portion 252 of optical receptacle 204 by rocker return spring 474. Rocker latch 714 extends through latch opening 488 of transceiver housing 140. In a midstroke position (not shown), handle 180 has been pivoted so that cams 812 and 816 have been pivoted to a position such that cams 812 and 816 press against raised edges 704 and 706, respectively, thereby forcing proximal end 732 of rocker 170 downwards and simultaneously causing rocker latch 714 to retract into latch opening 488 in a rocking movement. In an unlatched position (not shown), handle 180 has pivots to a horizontal position such that cams 812 and 816 exert their maximum force on raised edges 704 and 706, respectively and rocker latch 714 is entirely retracted into latch opening 488 as a result. The term “latched” refers to the ability of rocker latch 714 to lock transceiver module 102 in a transceiver cage, as described in detail below. When transceiver module 102 is in unlatched position transceiver frame 120 remains mounted in transceiver housing 140.

FIGS. 9A, 9B, 10A and 10B show transceiver module 102 with various parts removed to better show internal structures.

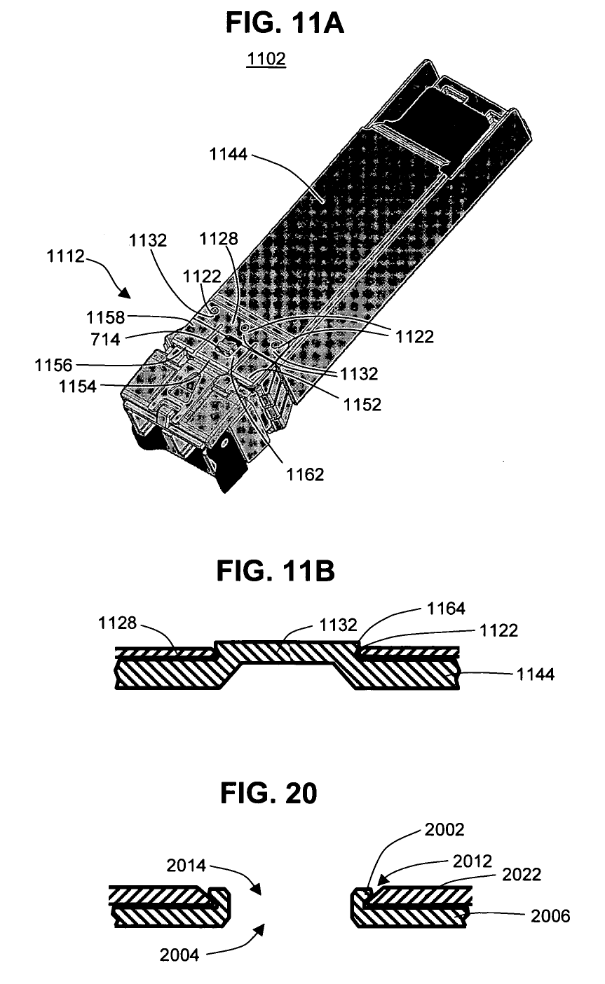

FIG. 11A is a bottom perspective view of an alternative embodiment of the transceiver module of the present invention that is similar to transceiver module 102. Transceiver module 1102 differs from transceiver module 102 by including a transceiver collar piece 1112 having three openings 1122 in a base portion 1128 that receive three bumps 1132 on a transceiver housing 1144. Transceiver collar piece 1112 includes three contact fingers 1152, 1154 and 1156 having respective bends 1158. Contact finger 1154 includes a latch opening 1162 through which rocker latch 714 extends. Contact fingers 1152, 1154 and 1156 extend at an angle from a receptacle base portion 252. Transceiver collar piece 1112 is held on transceiver housing 1144 using a “coining” procedure in which the tops of bumps 1132 are flattened to form a flattened portion 1164 that is wider than the diameter of the openings as shown in FIG. 11B.

FIGS. 12A and 12B illustrate a rectangular-shaped unibody cage collar 1202 in accordance with one embodiment of the present invention. Cage collar 1202 has a closed top side 1212, a closed right side 1214, a closed left side 1216 and a partially open bottom side 1218 including a gap 1220. Top side 1212 has five contact fingers 1222 extending distally from a top base portion 1224. Right side 1214 has three contact fingers 1226 extending distally from a right base portion 1228. Left side 1216 has three contact fingers 1232 extending distally from a left base portion 1234. Bottom side 1218 includes two bottom base portions 1236 and 1238 from which contact fingers 1240 and 1242 extend distally, respectively. Contact fingers 1222, 1226, 1232, 1240 and 1242 each include a bend 1250.

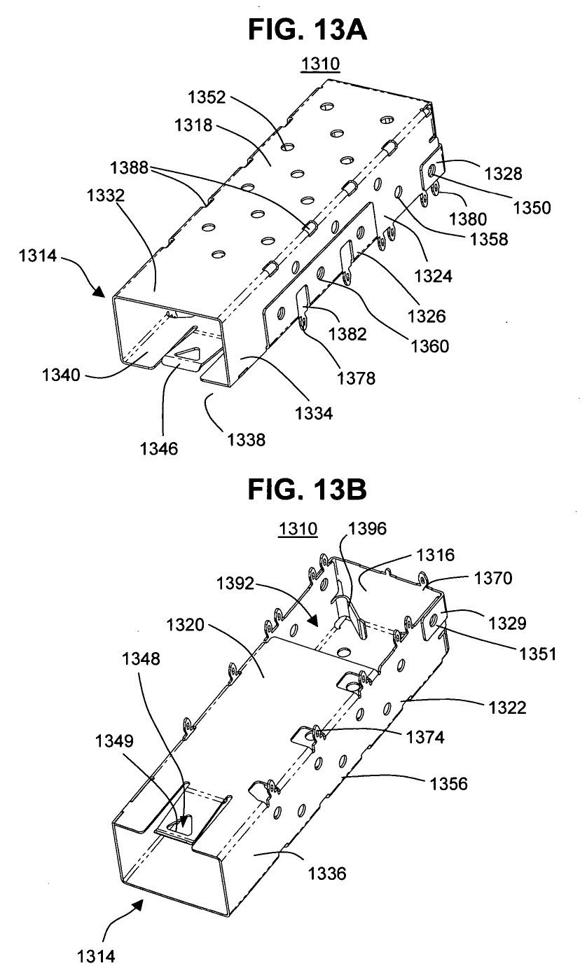

FIGS. 13A and 13B illustrate a cage body 1310 in accordance with one embodiment of the present invention. Cage body 1310 includes a proximal open end 1314, a distal wall 1316, a top portion 1318, a bottom portion 1320, a left side 1322, a right side 1324, and a right side flap 1326. Right side flap 1326 is held to right side 1324 by spot welding (not shown). A right back flap 1328 extends from distal wall 1316 and is bent to abut right side 1324. A left back flap 1329 extends from distal wall 1316 and is bent to abut left side 1322. Right back flap 1326 is held to right side 1324 and left back flap 1329 is held to left side 1322 by spot welding (not shown). Proximal open end 1314 includes a solid top proximal portion 1332, a solid right proximal portion 1334, a solid left proximal portion 1336, a bottom right solid portion 1338, a bottom left solid portion 1340, and a bottom spring 1346 having a triangular latch opening 1348 having a proximal edge 1349. Spring 1346 is biased upwardly.

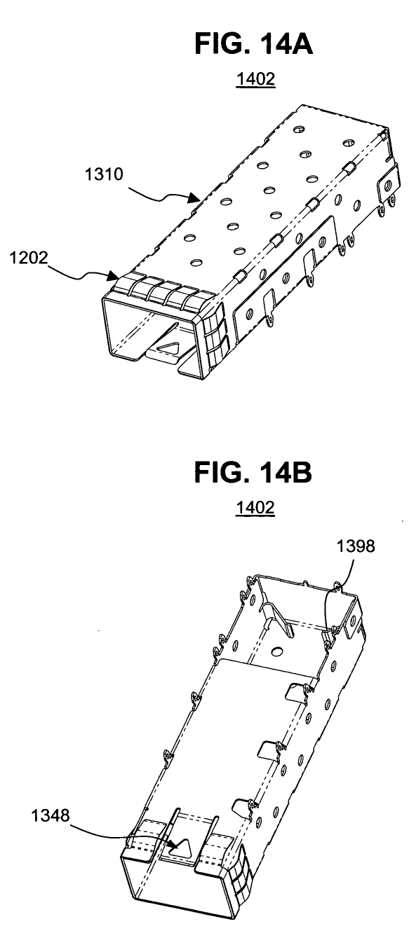

Distal wall 1316 does not include radiation control openings, right back flap 1328 includes a radiation control opening 1350, left back flap 1329 includes a radiation control opening 1351, top portion 1318 includes radiation control openings 1352, left side 1322 includes radiation control openings 1356, right side 1324 includes radiation control openings 1358, and right side flap 1326 includes radiation control openings 1360. Extending from distal wall 1316 are distal mounting pins 1370, extending from left side 1322 are left mounting pins 1374, and extending from right side 1324 are right proximal mounting pins 1378 and right distal mounting pins 1380. Right proximal oval mounting pins 1378 extend through locking openings 1382 in bottom portion 1320, thereby causing right side flap 1326 to abut against and be in electrical contact with right side 1324. In use, cage body 1310 is mounted on a printed wiring board (not shown). Cage body 1310 includes rectangular openings 1388 to aid in bending cage body 1310 during the making of cage body 1310. Cage body 1310 also includes an opening 1392 and a right distal spring 1396 and a left distal spring 1398 (shown in FIG. 14B).

The cage body of FIG. 13 is similar to the transceiver cage shown in FIGS. 5A and 5B of U.S. patent application Ser. No. 10/781,916 to Kayner et al. filed Feb. 20, 2004, the entire contents and disclosure of which is incorporated herein by reference, except that the cage body of FIG. 13 does not include contact fingers.

FIGS. 14A and 14B illustrate a transceiver cage 1402 in accordance with one embodiment of the present invention in which cage collar 1202 is mounted on cage body 1310. Cage collar traverses solid top proximal portion 1332, solid right proximal portion 1334, solid left proximal portion 1336, bottom right solid portion 1338 and bottom left solid portion 1340 of cage body 1310. Contact fingers 1222, 1226, 1232, 1240 and 1242 are designed to make electrical contact with a chassis (not shown) in which transceiver cage 1402 is mounted. Cage collar 1202 is held on cage body 1310 by spot welding top base portion, right base portion 1228, left base portion 1234 and bottom base portions 1236 and 1238 of cage collar 1202 to solid top proximal portion 1332, solid right proximal portion 1334, solid left proximal portion 1336, bottom right solid portion 1338 and bottom left solid portion 1340, respectively, of cage body 1310.

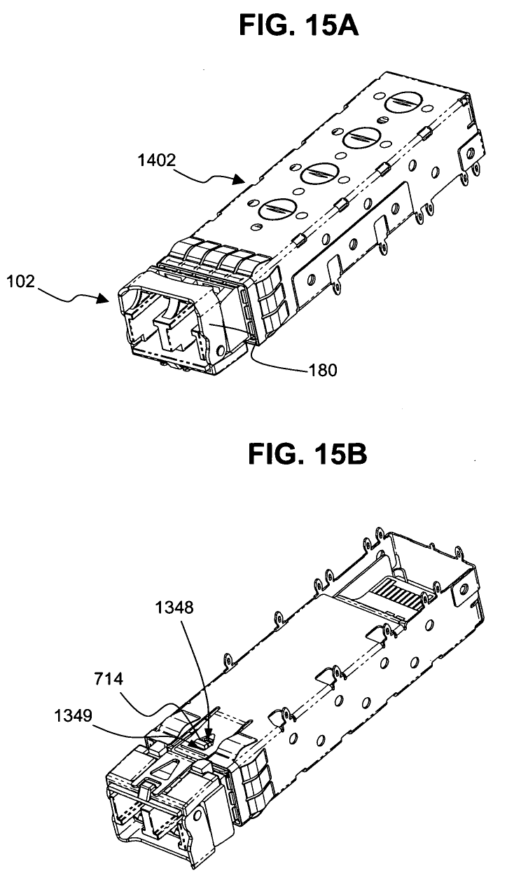

FIGS. 15A and 15B illustrate transceiver module 102 inserted into transceiver cage 1402 in a locked position with rocker latch 714 extending through triangular latch opening 1348 and releasably held against proximal edge 1349 of latch opening 1348 of transceiver cage 1402. When rocker latch 714 is released from proximal edge 1349 by rotating handle 180, transceiver module 102 is urged proximally and partially ejected from transceiver cage 1402 by springs 1396 and 1398 (not shown).

FIGS. 16A and 16B illustrate a rectangular-shaped unibody cage collar 1602 in accordance with one embodiment of the present invention. Cage collar 1602 has a closed top side 1612, a closed right side 1614, a closed left side 1616, a closed bottom side 1618, and an open corner 1620. Top side 1612 has five contact fingers 1622 extending distally from a top base portion 1624. Right side 1614 has three contact fingers 1626 extending distally from a right base portion 1628. Left side 1616 has three contact fingers 1632 extending distally from a left base portion 1634. Bottom side 1618 includes a bottom base portion 1636 including two side contact fingers 1640 and one center contact finger 1642 that extend distally. Center contact finger 1642 includes a triangular latch opening 1644. Contact fingers 1622, 1626, 1632, 1640 and 1642 each include a bend 1650.

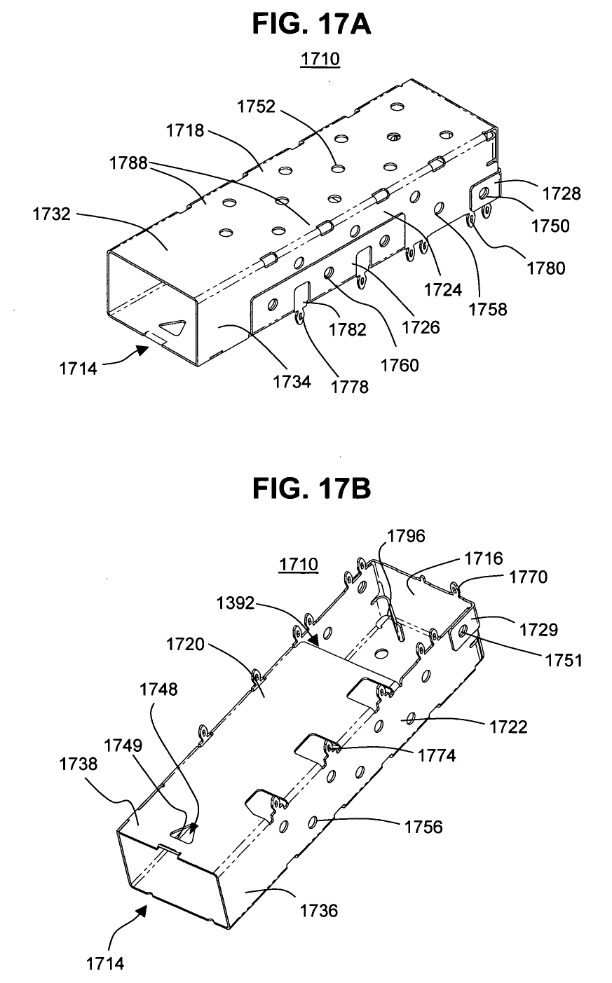

FIGS. 17A and 17B illustrate a cage body 1710 in accordance with one embodiment of the present invention. Cage body 1710 includes a proximal open end 1714, a distal wall 1716, a top portion 1718, a bottom portion 1720, a left side 1722, a right side 1724, and a right side flap 1726. Right side flap 1726 is held to right side 1724 by spot welding (not shown). A right back flap 1728 extends from distal wall 1716 and is bent to abut right side 1724. A left back flap 1729 extends from distal wall 1716 and is bent to abut right side 1722. Right back flap 1728 is held to right side 1724 and left back flap 1729 is held to left side 1722 by spot welding (not shown). Proximal open end 1714 includes a solid top proximal portion 1732, a solid right proximal portion 1734, a solid left proximal portion 1736, and a bottom portion 1738 including a triangular latch opening 1748 having a proximal edge 1749.

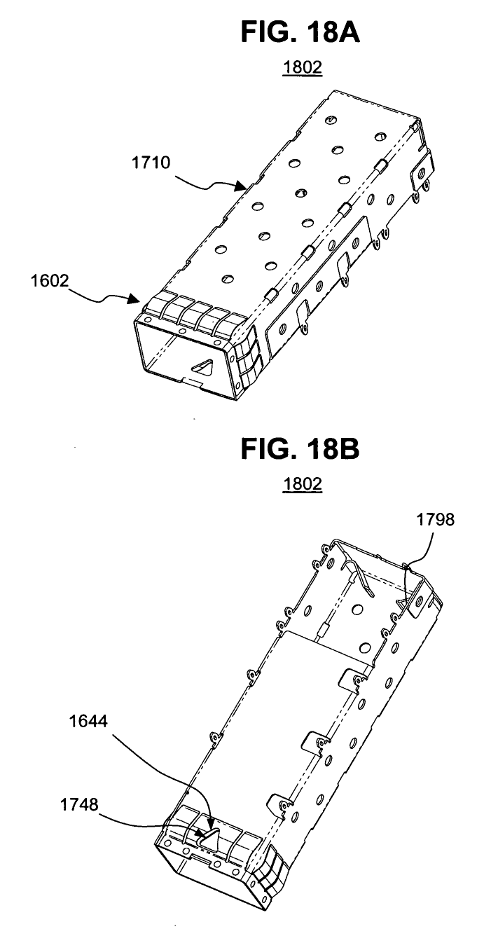

Distal wall 1716 does not include radiation control openings, right back flap 1728 includes a radiation control opening 1750, left back flap 1729 includes a radiation control opening 1751, top portion 1718 includes radiation control openings 1752, left side 1722 includes radiation control openings 1756, right side 1724 includes radiation control openings 1758, and right side flap 1726 includes radiation control openings 1760. Extending from distal wall 1716 are distal mounting pins 1770, extending from left side 1722 are left mounting pins 1774, and extending from right side 1724 are right proximal mounting pins 1778 and right distal mounting pins 1780. Right proximal oval mounting pins 1778 extend through locking openings 1782 in bottom portion 1720, thereby causing right side flap 1726 to abut against and be in electrical contact with right side 1724. In use, cage body 1710 is mounted on a printed wiring board (not shown). Cage body 1710 includes rectangular openings 1788 to aid in bending cage body 1710 during the making of cage body 1710. Cage body 1710 also includes an opening 1792 and a right distal spring 1796 and a left distal spring 1798 (shown in FIG. 18B).

The cage body of FIG. 17 is similar to the transceiver cage shown in FIGS. 5A and 5B of U.S. patent application Ser. No. 10/781,916 to Kayner et al. filed Feb. 20, 2004, the entire contents and disclosure of which is incorporated herein by reference, except that the cage body of FIG. 17 does not include contact fingers or a bottom spring.

FIGS. 18A and 18B illustrate a transceiver cage 1802 in accordance with one embodiment of the present invention in which cage collar 1602 is mounted on cage body 1710. Cage collar traverses solid top proximal portion 1732, solid right proximal portion 1734, solid left proximal portion 1736, and bottom portion 1738. Triangular latch opening 1644 of cage collar 1602 is aligned with triangular latch opening 1748 of cage body 1710.

Contact fingers 1622, 1626, 1632, 1640 and 1642 are designed to make electrical contact with a chassis (not shown) in which transceiver cage 1802 is mounted. Cage collar 1602 is held on cage body 1710 by spot welding top base portion, right base portion 1628, left base portion 1634 and bottom base portion 1636 of cage collar 1602 to solid top proximal portion 1732, solid right proximal portion 1734, solid left proximal portion 1736, and bottom portion 1738, respectively, of cage body 1710.

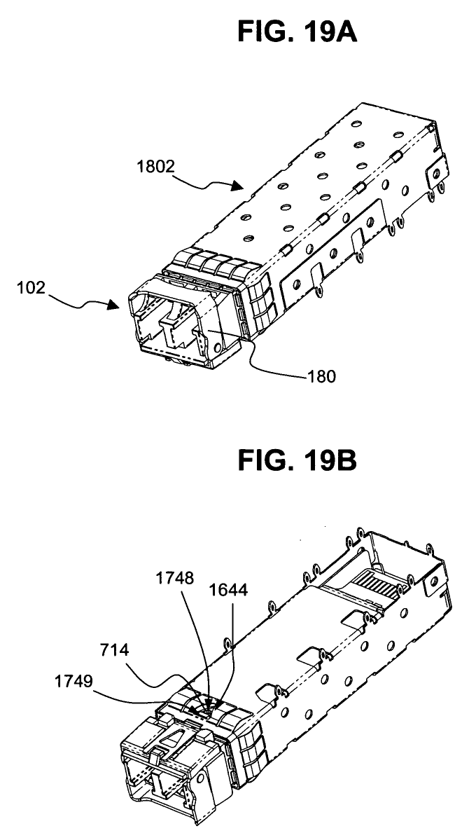

FIGS. 19A and 19B illustrate transceiver module 102 inserted into transceiver cage 1802 in a locked position with rocker latch 714 extending through triangular latch opening 1748 and latch opening 1644 of cage collar 1602. Rocker latch 714 is releasably held against proximal edge 1749 of latch opening 1748 of transceiver cage 1802. When rocker latch 714 is released from proximal edge 1749 by rotating handle 180, transceiver module 102 is urged proximally and partially ejected from transceiver cage 1802 by springs 1796 and 1798 (not shown).

A cage collar of the present invention may be formed by cutting, bending and punching a single sheet of a metal such as steel. A cage collar may also be thinner than the cage body on which the cage collar is mounted. In one embodiment, the cage collar has a thickness of about 50 microns to 250 microns. The contact fingers of the cage collar of the present invention may have various finger widths. In one embodiment of the present invention, the contact fingers have a finger width of about 2 mm. The gaps between adjacent contact fingers may be of various sizes. In one embodiment the gaps between adjacent contact fingers are 0.5 mm. In some embodiments of the present invention, there may just be a single solid contact finger on each side of the cage collar.

Although in the embodiments of the present invention described above, the cage collars are mounted on the cage body by spot welding, a cage collars of the present invention may also be mounted on a cage body of the present invention using a “coining” procedure, as described above and shown in FIG. 11B, by forming bumps on the cage body and including corresponding openings in the base portions of the cage collar.

Although in the embodiments described above, the cage body is held together using spot welding, a cage body of the present invention may also be held together by a “crimping” procedure illustrated in FIG. 20. As shown in FIG. 20, an edge 2002 of an opening 2004 in a side flap 2006 is crimped around an edge 2012 of an opening 2014 of a side of a cage body 2022. Several aligned openings 2004 and 2014 may be so crimped together. Such crimping may be performed using a mandrel and die using procedures that are well known in the art. A cage body of present invention may also be held together using a “coining” procedure similar to the procedures described above.

Although in the embodiments described above, the cage body includes rectangular openings to aid in bending during the making of the cage body from a single piece of material, a cage body of the present invention does not require such openings.

Although several combinations of transceiver modules and transceiver cages are described and shown above, it should be understood that the transceiver modules of the present invention may be used with various types of transceiver cages, including various existing transceiver cages, and that the transceiver cages of the present invention may be used with various types of transceiver modules, including various existing transceiver modules.

The latching and unlatching of the transceiver module from a transceiver cage in the embodiments of the present invention described above and shown in the drawings is similar to the procedure described and shown for the transceiver module and transceiver cage shown in FIGS. 1A, 1B, 1C, 1D, 1E, 1F, 1G, 1H, 1I, 1J, 1K, 2A, 2B, 3A, 3B, 4A, 4B, 5A,5B, 6A, 6B, and 6C of U.S. patent application Ser. No. 10/781,916 to Kayner et al. filed Feb. 20, 2004, the entire contents and disclosure of which is incorporated herein by reference.

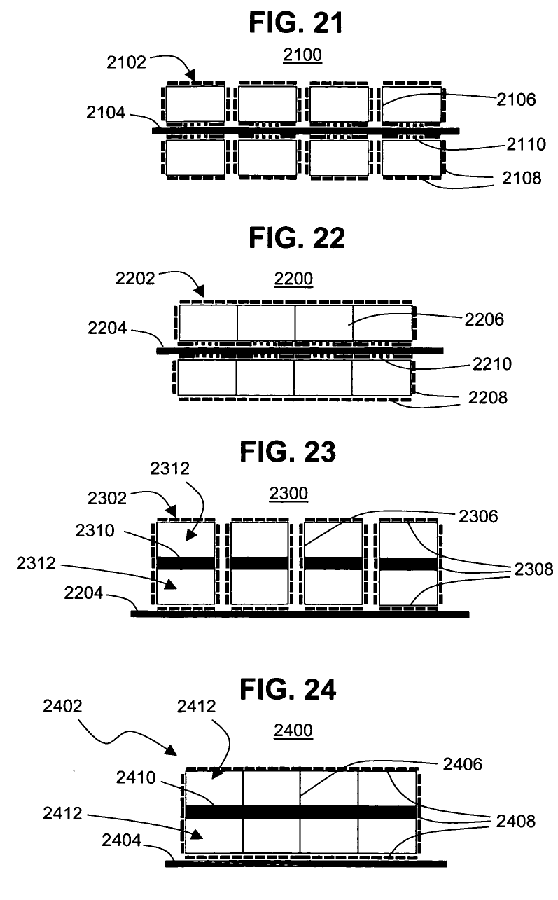

FIGS. 21, 22, 23 and 24 illustrate examples of use of the inventive concept in various configurations of cages for accommodating multiple transceivers. In each example, accommodation of 8 transceivers is illustrated, but it is understood that the invention is valid for any number of transceivers. In three of the examples, a single cage accommodates a plurality of transceivers, and such cages are denoted as A×B when they accommodate A transceivers in the vertical dimension and B transceivers horizontally.

FIG. 21 illustrates a cage assembly 2100 in accordance with one embodiment of the present invention in which eight (8) separate 1×1 cages 2102 are mounted on both sides of printed circuit board 2104 (PCB) in the “belly-to-belly” configuration. Each cage 2102 may be in the form of any of the cages described herein in FIGS. 14A and 14B and FIGS. 18A and 18B. Substantially surrounding each cage body 2106 are EMI fingers 2108. Optionally, an additional EMI finger 2110 may reside over the latch opening of the cage.

FIG. 22 illustrates a cage assembly 2200 in accordance with one embodiment of the present invention in which two (2) separate 1×4 multi-cages 2202 are mounted on both sides of PCB 2204 in the “belly-to-belly” configuration. Each multi-cage 2202 may contain features of any of the cages described herein in FIGS. 14A and 14B and FIGS. 18A and 18B. Substantially surrounding 1×4 multi-cage body 2206 are EMI fingers 2208. Optionally, an additional EMI finger 2210 may reside over each latch opening of the cage.

FIG. 23 illustrates a cage assembly 2300 in accordance with one embodiment of the present invention in which four (4) separate 2×1 multi-cages 2302 are mounted on one side of PCB 2304. Each multi-cage 2302 may contain features of any of the cages described herein in FIGS. 14A and 14B and FIGS. 18A and 18B. Substantially surrounding 2×1 multi-cage body 2306 are EMI fingers 2308. A preferred configuration is for the transceivers to be configured belly-to-belly within 2×1 multi-cages 2302. In this case, both latch openings are interior to 2×1 multi-cage 2302. To minimize EMI leakage, each 2×1 multi-cage 2302 includes a faceplate 2310, which may comprise the same sheet of metal from which 2×1 multi-cage body 2306 is formed. For a “tongueless” transceiver cage, such as the transceiver cage of FIGS. 18A and 18B, faceplate 2310 may cover the entire area between two proximal openings 2312 into which respective transceivers (not shown) may be inserted.

FIG. 24 illustrates 2×4 multi-cage 2402 mounted on one side of PCB 2404. 2×4 multi-cage 2402 may contain features of any of the cages described herein in FIGS. 14A and 14B and FIGS. 18A and 18B. Substantially surrounding 2×4 multi-cage body 2406 are EMI fingers 2408. A preferred configuration is for the transceivers to be configured belly-to-belly within 2×4 multi-cage 2402. In this case, all latch openings are interior to 2×4 multi-cage 2402. To minimize EMI leakage, 2×4 multi-cage 2402 includes faceplates 2410, which may comprise the same sheet of metal from which 2×4 multi-cage body 2406 is formed. For a “tongueless” transceiver cage, such as the transceiver cage of FIGS. 18A and 18B, faceplate 2410 may extend the entire width of multi-cage 240 and, thereby, cover the entire area between each vertically arranged pair of proximal openings 2412 into which respective transceivers (not shown) may be inserted

All documents, patents, journal articles and other materials cited in the present application are hereby incorporated by reference.

Although the present invention has been fully described in conjunction with several embodiments thereof with reference to the accompanying drawings, it is to be understood that various changes and modifications may be apparent to those skilled in the art. Such changes and modifications are to be understood as included within the scope of the present invention as defined by the appended claims, unless they depart therefrom.

What is claimed is:

1. A device comprising an EMI-minimized transceiver.

2. The device of claim 1, wherein the transceiver comprises a circuit board mounted in a transceiver housing, wherein the transceiver housing has opening-free sides and a unibody construction.

3. The transceiver module of claim 1, wherein the transceiver housing has opening-free top.

4. A device comprising:
a rectangular-shaped collar comprised of an electrically conductive material, the collar including: four collar sides for mounting on four exterior sides of a cage body;
and a plurality of contact fingers on the four collar sides for making electrical contact with a chassis in which a transceiver cage comprising the collar and the cage body is mounted.

5. The device of claim 4, wherein there are a plurality of the contact fingers on each of the four collar sides.

6. The device of claim 4, wherein the collar has a unibody construction.

7. The device of claim 4, wherein the collar substantially traverses the four exterior sides.

8. The device of claim 4, wherein one of the collar sides includes an opening for receiving a locking latch of a transceiver mounted in the cage body.

9. The device of claim 4, wherein the device further comprises the cage body.

10. The device of claim 9, wherein the collar is welded to the cage body.

11. The device of claim 9, further comprising a transceiver inserted in the transceiver cage.

12. The device of claim 9, wherein the collar covers respective proximal portions of the exterior sides and wherein the proximal portions are substantially solid except for an opening in one of the front portions for receiving a locking latch of transceiver mounted in the transceiver

13. The device of claim 12, wherein one of the collar sides includes an opening for allowing the latch on the transceiver to extend therethrough.

14. The device of claim 12, wherein the collar is thinner than the cage body.

15. The device of claim 12, wherein the collar is made from a different material than the cage body.

16. The device of claim 4, further comprising a alignment means for aligning the collar on the cage body.

17. The device of claim 16, wherein the alignment means comprises a first alignment means on the collar that engages a second alignment means on the cage body.

18. A device comprising:
a collar piece including: one or more contact fingers for mounting on an exterior side of cage body and for making electrical contact with a chassis in which a transceiver cage comprising the collar and the cage body is mounted, wherein the exterior side includes an opening for receiving a locking latch of a transceiver inserted in a transceiver comprising the collar piece and the cage body.

19. The device of claim 18, wherein the one or more contact fingers comprise a plurality of contact fingers.

20. The device of claim 18, wherein the one or more contact fingers includes a contact finger having a contact finger opening for receiving the locking latch.

21. The device of claim 18, further comprising the cage body.

22. The device of claim 21, further comprising the transceiver.
